(19) United States
(12) Patent Application Publication
(10) Pub. No.: US 2006/0031564 A1
(43) Pub. Date: Feb. 9, 2006

(54) Methods and systems for streaming data at increasing transmission rates

(76) Inventors: John T. Brassil, Los Gatos, CA (US); Puneet Sharma, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/852,907

(22) Filed: May 24, 2004

(51) Int. Cl. G06F 15/16

(52) U.S. Cl. 709/233

(57) ABSTRACT

Methods of streaming data, and systems thereof, are described. Data encoded at a first encoding rate is streamed at a first transmission rate. The first encoding rate corresponds to a first playback rate. The first transmission rate is increased by an incremental amount to an intermediate transmission rate that is greater than the first playback rate. The intermediate transmission rate is then increased to a second transmission rate that corresponds to a second encoding rate. The data encoded at the first encoding rate is streamed at the second transmission rate. A determination is made whether there is network bandwidth sufficient for the second transmission rate. If so, data encoded at a second encoding rate is streamed at the second transmission rate in place of the data encoded at the first encoding rate.

### TECHNICAL FIELD

Embodiments of the present invention relate to the field of streaming media data.

### BACKGROUND ART

Stored media data (e.g., audio and video data) available on-demand from media servers is frequently encoded (compressed) at multiple bit rates to support rate adaptation for transmission to receivers over congested or low bandwidth network links. A receiver initially identifies its capabilities and capacities to a source of media data (e.g., a media server). For example, the receiver can notify the media server of the maximum bandwidth of the receiver's network connection. In response, the media server selects data that is encoded at the highest bit rate that does not exceed the maximum bandwidth of the receiver, and streams the encoded data at a bit rate that corresponds to the encoding rate. The higher the bit rate, the better the playback quality of the streamed media data. Hence, different levels of quality can be transmitted based on the bandwidth available between the media server and the receiver.

After streaming begins, the receiver can provide feedback to the media server with regard to whether or not all of the data is being received. Should the feedback indicate that not all of the data is being received, the media server concludes that less than the expected bandwidth is available. Accordingly, the media server selects data that is encoded at the next lowest bit rate and streams that data to the receiver at a correspondingly lower bit rate.

A substantial amount of the media data that is streamed over the Internet is delivered using HyperText Transfer Protocol (HTTP). The sharing of network resources with other applications encourages media applications to use either Transmission Control Protocol (TCP) or TCP-friendly rate control mechanisms. The conventional art is problematic because the transport requirements for media applications are generally poorly matched to the transport services provided by a TCP connection. A media application has no effective means of communicating its bandwidth needs to TCP rate control mechanisms. Conversely, the transport layer provides little help to an application that may benefit from an increase in transmission rate. For instance, after selecting and streaming data encoded at a lower bit rate because of perceived network congestion, it would be beneficial to revert back to data encoded at a higher bit rate when the congestion is alleviated and/or additional bandwidth capacity becomes available. However, a media server, without taking action to either measure or capture available bandwidth, does not receive an explicit indication of bandwidth availability, and so is unaware of any change to the available bandwidth.

In summary, there is an overall desire to increase the playback quality of media data at a receiver. One way to increase quality is to stream data that is encoded at a higher bit rate. However, this requires a higher transmission rate, which can result in lost data if bandwidth is not available. Thus, higher encoding and transmission rates may actually result in a decrease in playback quality. To address reduced bandwidth, either real or perceived, data encoded at lower bit rates is streamed at lower transmission rates. This too can decrease the playback quality at the receiver. The preference is for the media server to select and stream data encoded at the higher bit rate when bandwidth is available, but the media server does not have that information. The present invention provides a solution to these problems as well as other advantages.

### DISCLOSURE OF THE INVENTION

Embodiments of the present invention pertain to methods of streaming data, and systems thereof. In one embodiment, data encoded at a first encoding rate is streamed at a first transmission rate. The first encoding rate corresponds to a first playback rate. The first transmission rate is increased by an incremental amount to an intermediate transmission rate that is greater than the first playback rate. The intermediate transmission rate is then increased to a second transmission rate that corresponds to a second encoding rate. The data encoded at the first encoding rate is streamed at the second transmission rate. A determination is made whether there is network bandwidth sufficient for the second transmission rate. If so, data encoded at a second encoding rate is streamed at the second transmission rate in place of the data encoded at the first encoding rate.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a representation of a network upon which embodiments of the present invention may be implemented.

FIG. 2 is a block diagram of a streaming server according to one embodiment of the present invention.

FIG. 3 is a block diagram illustrating a streaming operation according to one embodiment of the present invention.

FIGS. 4A and 4B are graphs illustrating transmission rates as a function of time according to one embodiment of the present invention.

FIG. 5 is a flowchart of a process for streaming data according to one embodiment of the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

The descriptions and examples provided herein are discussed in the context of encoded (compressed) media data (also referred to as multimedia data or media content). One example of multimedia data is video data accompanied by audio data; for example, a movie with soundtrack. However, media data can be video only or audio only. In general, the present invention, in its various embodiments, is well-suited for use with data that is encoded, or can be encoded, at different bit rates, such as but not limited to audio and video data. In addition, the present invention, in its various embodiments, is well-suited for use with data that may not be encoded.

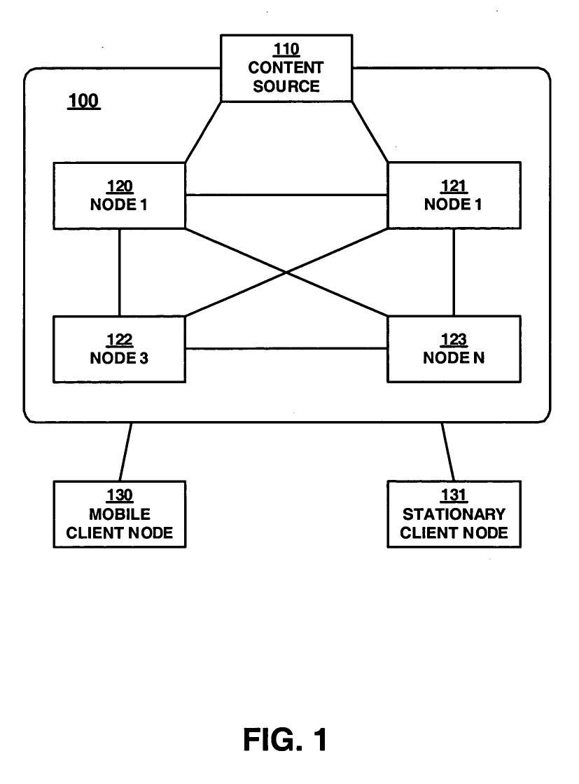

FIG. 1 is a representation of a network 100 upon which embodiments of the present invention may be implemented. In the present embodiment, network 100 includes a content source 110 (e.g., a media server) coupled to a number of interconnected nodes 120, 121, 122 and 123. There may of course be a greater or lesser number of content sources and nodes than those illustrated.

The interconnections between these nodes, including content source 110, may be a wired connection, a wireless connection, or a combination thereof. Each interconnection includes one or more channels, so that multiple streaming sessions between nodes can take place in parallel.

Generally speaking, content source 110 and nodes 120-123 are types of devices that provide the capability to process and store data, and/or to send and receive such data (e.g., servers, routers, switches, etc.). Accordingly, nodes 120-123 may be computer systems as well as other types of devices that may not be typically considered computer systems but have similar capabilities.

In communication with network 100 are client devices such as mobile client node 130 and stationary client node 131. In one embodiment, network 100 is for streaming media data to client nodes 130 and/or 131. There may be a greater or lesser number of client nodes than those illustrated. The client nodes 130 and 131 may be coupled to the network 100 via a wired connection, a wireless connection, or a combination thereof.

In general, network 100 provides the capability to provide data from content source 110, and/or from any of the intermediate nodes 120-123, to the client nodes 130-131. The route, or path, taken by the data as it travels from the content source 110 to the client nodes 130-131 may pass through any number of intervening nodes and interconnections between those nodes.

Generally speaking, embodiments of the present invention pertain to the streaming of data packets from a sender to a receiver. Any of the nodes 120-123 and content source 110 may be considered to be a sender, and similarly any of the nodes 120-123 and client nodes 130-131 may be considered to be a receiver. The sender and receiver nodes may be adjacent nodes, or they may be separated by intervening nodes.

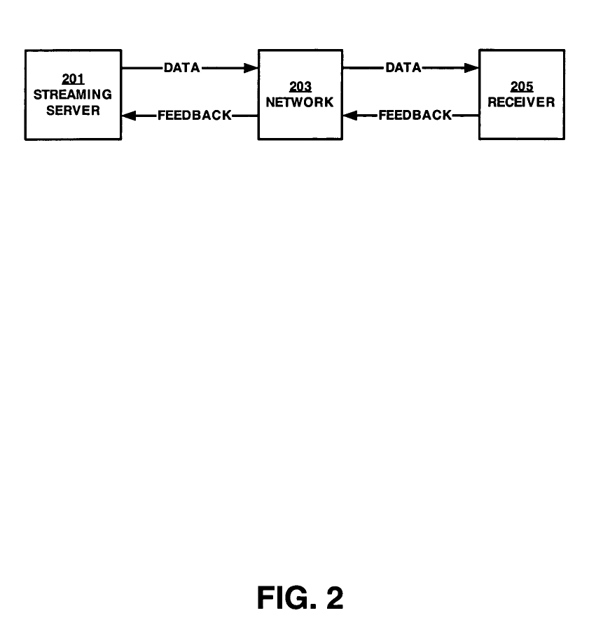

FIG. 2 is a block diagram illustrating a streaming operation according to one embodiment of the present invention. The example of FIG. 2 shows a first node (streaming server 201) and a second node (receiver 205) communicating over a network 203 such as network 100 of FIG. 1. As noted, there may be other nodes between streaming server 201 and receiver 205.

In general, streaming server 201 of FIG. 2 is a device that sends media data to receiver 205. Receiver 205 can provide feedback about network performance to streaming server 201. For example, receiver 205 can inform streaming server 201 of the available bandwidth, the average data packet loss rate, and/or which data packets have been correctly received. Feedback received by streaming server 201 can also include information such as, but not limited to, data packet delivery rates, the time needed to traverse the path to receiver 205, and delays known to be associated with the path to receiver. Streaming server 201 can also receive feedback from other sources, such as network management or monitoring devices.

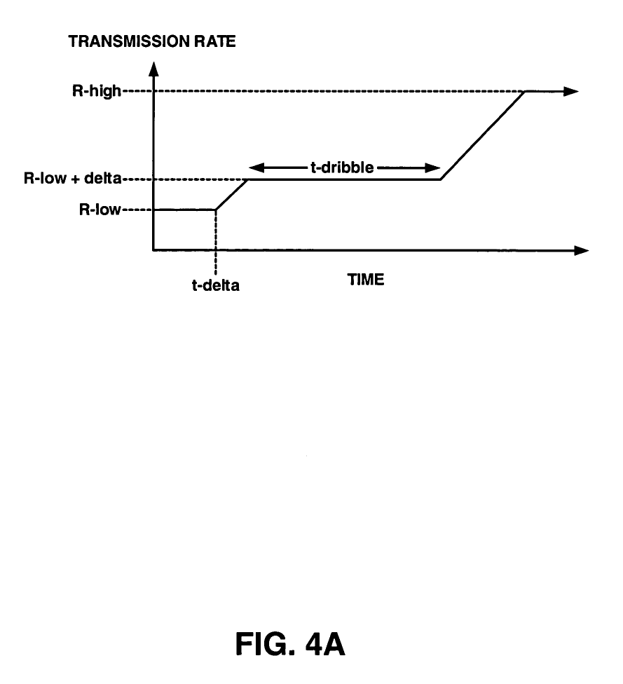

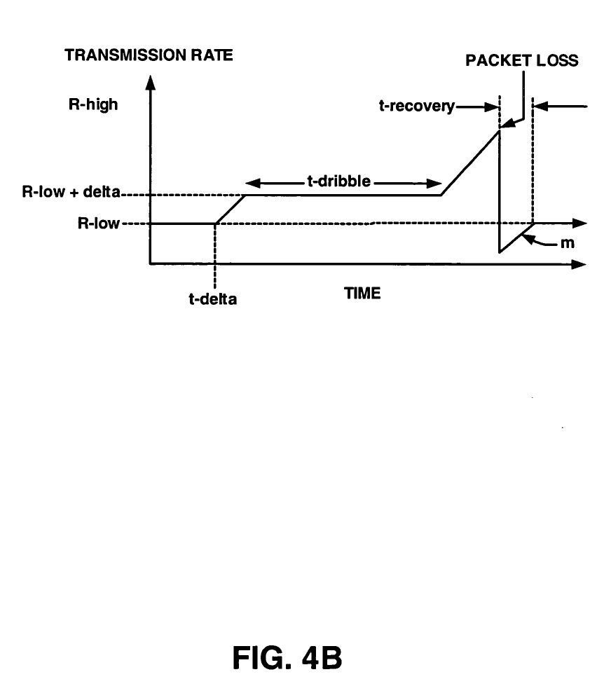

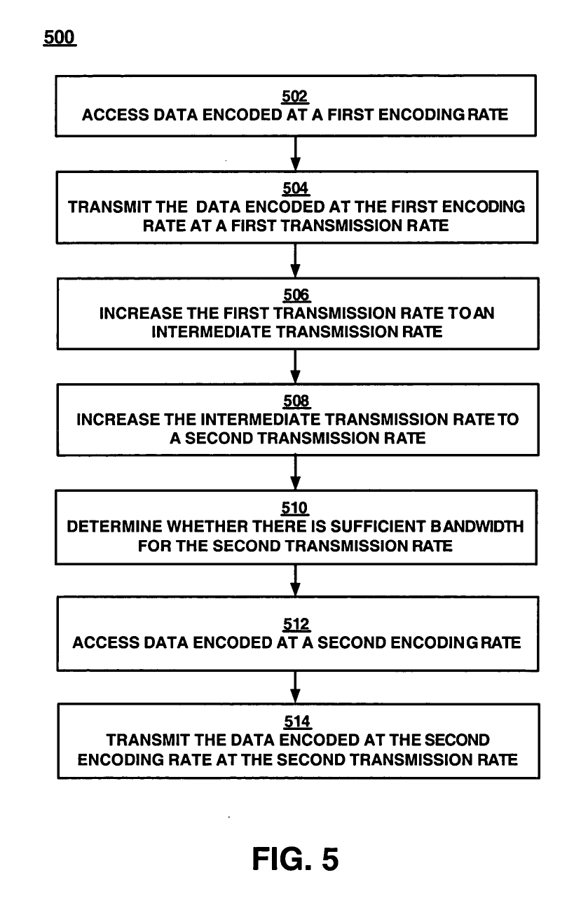

According to the various embodiments of the present invention, using the feedback received from receiver 205 and perhaps other feedback as just described, streaming server 201 can change the rate at which data are transmitted to receiver 205. Also, if the data are encoded (compressed) at different encoding rates, then streaming server 201 can select and stream data that is encoded at a different encoding rate. Specifically, streaming server 201 can increase the transmission rate and, at the higher transmission rate, stream data that is encoded at a higher encoding rate. Additional information is provided below in conjunction with FIGS. 4A and 5.

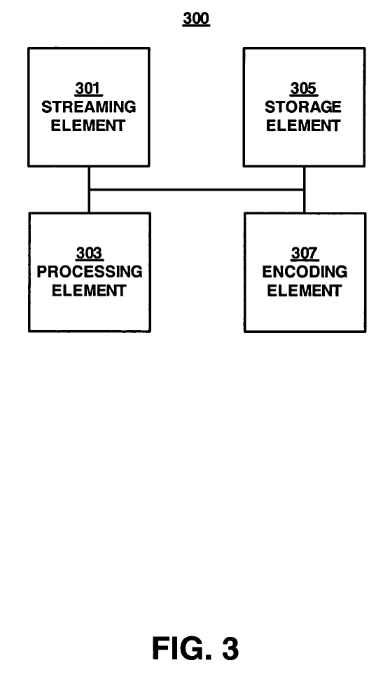

FIG. 3 is a block diagram of a streaming server 300 according to one embodiment of the present invention. Streaming server 300 may be any of the nodes 120-123 or content source 110 of FIG. 1. In the example of FIG. 3, streaming server 300 includes streaming element 301, processing element 303, storage element 305 and encoding element 307, each element linked to the others.

Steaming element 301 is for streaming data to a receiver. Based on feedback received from receiver 205 of FIG. 2, and perhaps other feedback as described above, processing element 303 makes a determination as to whether or not to increase the transmission rate and to stream data that is encoded at a higher encoding rate.

In the present embodiment, encoding element 307 of FIG. 3 is for encoding (compressing) data using any available encoding scheme. The output of encoding element 307 can be stored in a storage element such as storage element 305, where it can be accessed by streaming element 301. Storage element 305 can be an element separate from streaming server 300 or incorporated into streaming server 300. In the latter case, the output of encoding element 307 is provided to streaming server 300, which can store the output of encoding element 307 in whole or in part before streaming the data packets to a receiver. Alternatively, streaming server 300 can incorporate encoding element 307 (e.g., streaming server 300 and encoding element 307 are integrated within a single device). In general, the encoding and streaming operations can overlap or they can occur in series, separated by any amount of time. The encoding and streaming operations can be performed by a single device or by multiple devices. The output of the encoding operation can be stored in whole or in part by the encoding device, by the streaming device, or by a storage element separate from those devices.

The data can be encoded at any number of encoding rates. In general, an encoding rate refers to a bit rate that corresponds to the intended rate at which the encoded data is to be played back at a receiver. As an example, audio (e.g., music) data can be encoded as Moving Pictures Experts Group-2 (MPEG-2) layer III (MP3) data at rates of 128, 96 and 64 kilobits per second (kbs). The encoded data identifies its encoding rate. At the receiver, the encoded data is generally played back at the encoding rate. As used herein, the terms “playback” and “play back” refer generally to the processing and use of the encoded data at the end-user receiver. For instance, playback of audio data refers to the processing and audible rendering of the audio data, and playback of video data refers to the processing and visual rendering of the video data.

Although the data can be encoded at any number of encoding rates, the number of encoding rates is typically few, and hence the granularity of rate adjustments is often large. This is generally referred to as coarse-grain rate control. As will be seen by the coming discussion, the present invention in its various embodiments is particularly advantageous with coarse-grain rate control. However, the present invention is not so limited. That is, embodiments of the present invention can be used with fine-grain encoding techniques, in which encoding rates are closer to being continuous.

FIG. 4A is a graph illustrating the rates at which a streaming server (e.g., streaming server 300 of FIG. 3) transmits data as a function of time according to one embodiment of the present invention. Data encoded at multiple rates can be stored in different files (e.g., one encoding rate per file) or in the same file. For simplicity of discussion, it is convenient to consider a case in which there are two encoding rates (R_{low} and R_{high}) drawn from one of two files, with D_{low} and D_{high} representing the stored encoded data for the lower and higher encoding rates, respectively. At steady state, the files would be read and streamed at average rates R_{low} and R_{high}, respectively. At the receiver, the data would be played back at those average rates R_{low} and R_{high}, respectively.

In FIG. 4A, the streaming server is transmitting data at the rate R_{low}, with R_{high} representing the next highest encoding rate. At time t_{delta}, the streaming server decides to probe the network (specifically, the communication channel or path from the streaming server to the receiver) to determine if there is sufficient bandwidth available for an increase in transmission rate. The time t_{delta} may be set according to historical information about network performance. Alternatively, the streaming server may make its decision to increase transmission rate based on information it is receiving about network performance.

In the example of FIG. 4A, the streaming server accelerates the delivery of the data encoded at the lower encoding rate R_{low} by increasing the transmission rate by an incremental amount Δ. Thus, starting at time t_{delta} plus any time needed to ramp up to the increased rate, data encoded at the lower encoding rate R_{low} is streamed to a receiver at the rate R_{low}+Δ. However, the receiver continues to play back the data at the rate R_{low}. As a result, data will accumulate in a buffer or other memory element at the receiver. As will be seen from the discussion below, the data accumulated at the receiver performs an important role in maintaining the perceptual quality of the played back data.

In the example of FIG. 4A, the streaming server continues to transmit data at the rate R_{low}+Δ for a period of time t_{dribble}. Then, the streaming server begins to send data encoded at the lower encoding rate R_{low} at the next higher transmission rate R_{high}. Using feedback from the receiver (or other information), the streaming server can make a determination as to whether sufficient bandwidth is available to support continued streaming at the higher transmission rate R_{high}. Upon determining that the bandwidth is available to sustain the higher transmission rate R_{high}, the streaming server begins to draw data encoded at the higher rate R_{high} from D_{high}, and to stream that data at the higher transmission rate R_{high} until the streaming session is concluded.

FIG. 4B illustrates a case in which the streaming server attempts to increase the transmission rate to R_{high} but is prevented from doing so because there is insufficient bandwidth available for the rate increase, causing one or more data packets to be lost (note that some degree of packet loss may be tolerable). According to Transmission Control Protocol (TCP), the transmission rate will be automatically reduced, perhaps to a rate that is less than R_{low}. In the example of FIG. 4B, the amount of time needed to return to the transmission rate R_{low} is designated as t_{recovery}. Here, the importance of the data accumulated and buffered at the receiver is realized. During t_{recovery}, the buffered data is drawn on and used during playback, so that from the perspective of the human user, there is no perceptible degradation in playback quality even though data is being received at the receiver at a reduced rate.

The incremental amount Δ is selected to be small enough to avoid challenging the limits on available bandwidth, but large enough to allow the data to accumulate at the receiver relatively quickly. The faster the data are accumulated at the receiver, the sooner the increase to the higher transmission rate can be accomplished and the sooner the data encoded at the higher encoding rate can be streamed and played back. Thus, a balance is struck between the size of the incremental amount Δ and the length of time t_{dribble}. In one embodiment, this balance is expressed as:
t_{dribble}>(R_{low})²/(8 mΔ),
where “m” is determined by the TCP rate control envelope. In the examples of FIGS. 4A and 4B, “m” is the slope of the lines at t_{delta}, after t_{dribble}, and during t_{recovery}. If t_{dribble} is sufficiently long, then enough data will accumulate at the receiver, and the receiver will be unaware of any data loss that may have occurred during the attempt to increase transmission rate and the subsequent attempt to reclaim the lower transmission rate R_{low}.

The examples of FIGS. 4A and 4B illustrate cases in which there is a single increase in transmission rate (to R_{low}+Δ) before the increase to R_{high}. Alternatively, there can be more than one such intermediate increase in transmission rate. Also, the examples of FIGS. 4A and 4B can be extended to cases in which there are more than two encoding and transmission rates. For instance, after achieving the higher transmission rate R_{high}, the transmission rate can be increased by another incremental amount after another period of time t_{delta}, in anticipation of further increasing the transmission rate to the next highest rate.

The process just described is contrasted to a conventional approach that may be applied by a streaming server. In such a conventional approach, upon deciding to attempt an increase in transmission rate, the streaming server would begin to transmit data from D_{high} (data encoded at the higher bit R_{high}) at the correspondingly higher transmission rate R_{high}. But suppose that the bandwidth is not available to sustain the higher transmission rate. For a time, the data encoded at the higher rate R_{high} is transmitted at the higher rate and accumulated at the receiver. But without sufficient bandwidth, packet losses will begin to occur. These losses are detected by the streaming server, which then retreats to transmitting the lower quality data (encoded at R_{low}) at the lower transmission rate R_{low}. The receiver that is exposed to this failed attempt to increase transmission rate will experience a burst of data at the higher quality level, followed by a return to the lower quality level. This transition between higher and lower quality data may be repeated over and over as the streaming server keeps trying to increase transmission rate. The differences between playback quality at higher and lower encoding/transmission rates is particularly noticeable with coarse-grain rate control, as the difference between the different levels of encoding/transmission rates can be relatively large. The back-and-forth transition between quality levels is typically perceived as being worse than simply maintaining the level of performance at the lower quality level. In some cases, playback may freeze because insufficient data was accumulated at the receiver before packet loss occurred.

FIG. 5 is a flowchart 500 of a process for streaming data according to one embodiment of the present invention. Although specific steps are disclosed in flowchart 500, such steps are exemplary. That is, embodiments of the present invention are well-suited to performing various other steps or variations of the steps recited in flowchart 500. It is appreciated that the steps in flowchart 500 may be performed in an order different than presented, and that not all of the steps in flowchart 500 may be performed. All of, or a portion of, the methods described by flowchart 500 may be implemented using computer-readable and computer-executable instructions which reside, for example, in computer-usable media of a computer system. Generally, flowchart 500 is implemented by streaming server 201 of FIG. 2.

In step 502 of FIG. 5, data that is encoded at a first (e.g., lower) encoding rate is accessed. As discussed previously herein, the data may be stored locally or it may be stored on another device. Alternatively, the data may be encoded as it is accessed.

In step 504, the data that is encoded at the lower encoding rate is transmitted to a receiver at a first (e.g., lower) transmission rate. Encoding of additional data may occur as encoded data are transmitted. The receiver plays back the encoded data at a first (e.g., lower) playback rate.

In step 506, the first transmission rate is increased to an intermediate transmission rate. The intermediate transmission rate is greater than the first playback rate, but less than a second (e.g., higher) encoding rate and hence less than a second (e.g., higher) playback rate. Data encoded at the first (lower) encoding rate is transmitted at the intermediate transmission rate. Streaming continues at the intermediate transmission rate for a predetermined period of time, allowing data encoded at the first (lower) encoding rate to accumulate in memory at the receiver.

In step 508, after the predetermined period of time of step 506 has passed, the intermediate transmission rate is increased to a second (higher) transmission rate. At this point in the process, data encoded at the first (lower) encoding rate continues to be transmitted at the higher transmission rate.

In step 510, a determination is made with regard to whether there is sufficient bandwidth available to accommodate the second (higher) transmission rate. This determination is made using feedback information received by the streaming server.

In step 512, if sufficient bandwidth is available, then data that is encoded at a second (e.g., higher) encoding rate is accessed. As discussed previously herein, the data may be stored locally or it may be stored on another device. Alternatively, the data may be encoded as it is accessed.

In step 514, the data that is encoded at the higher encoding rate is transmitted to a receiver at the second (e.g., higher) transmission rate. Encoding of additional data may occur as encoded data are transmitted. The receiver plays back the encoded data at a second (e.g., higher) playback rate after depletion of the accumulated data that was encoded at the lower encoding rate.

In summary, embodiments of the present invention improve the quality of streaming media data by capturing additional bandwidth as it becomes available. An application-level rate control technique safely probes for available bandwidth, rather than simply switching to higher encoding and transmission rates and relying on TCP rate control. According to the embodiments of the present invention, the delivery of data to a receiver is temporarily accelerated, providing an effective means of determining whether sufficient bandwidth is available for a larger rate increase. When sufficient bandwidth is not available, the streaming server can continue to transmit at the lower rate, and data accumulated at the receiver is used to avoid degradation in playback quality at the receiver.

In essence, according to embodiments of the present invention, accelerated delivery of lower bit rate data is used to probe a communication channel of a network for bandwidth that can be used to transmit data at the next higher bit rate. The receiver's available memory (buffer) capacity is used to store the lower bit rate data received during the accelerated portion of the delivery, and that data is used to mask unsuccessful attempts to subsequently raise the delivery rate even higher.

Thus, embodiments of the present invention successfully match content encoded at different bit rates—and consequently different qualities—to the bandwidth available on a communication channel. Operating in accordance with those embodiments, streaming servers are able to at least attempt to increase the transmission rate in the presence of increased bandwidth. Rather than blindly attempt to increase the transmission rate as is the convention, streaming servers operating in accordance with embodiments of the invention intelligently probe for available bandwidth. As a consequence, frequent changes to the playback quality are avoided, enhancing the playback quality as perceived by the end user.

Embodiments of the present invention are thus described. While the present invention has been described in particular embodiments, it should be appreciated that the present invention should not be construed as limited by such embodiments, but rather construed according to the following claims.

What is claimed is:

1. A method of streaming data, said method comprising:
streaming data encoded at a first encoding rate at a first transmission rate, said first encoding rate corresponding to a first playback rate;
increasing said first transmission rate by an incremental amount to an intermediate transmission rate that is greater than said first playback rate;
increasing said intermediate transmission rate to a second transmission rate that corresponds to a second encoding rate, wherein said data encoded at said first encoding rate are streamed at said second transmission rate;
determining whether there is bandwidth sufficient for said second transmission rate; and
streaming data encoded at a second encoding rate at said second transmission rate in place of said data encoded at said first encoding rate, said second encoding rate corresponding to a second playback rate.

2. The method of claim 1 further comprising:
encoding data at said first encoding rate.

3. The method of claim 1 further comprising:
encoding data at said second encoding rate.

4. The method of claim 1 wherein said first encoding rate and said first transmission rate are substantially equal and wherein said second encoding rate and said second transmission rate are substantially equal.

5. The method of claim 1 wherein said determining comprises:
receiving feedback from a receiver, said feedback indicative of whether data encoded at said first encoding rate is being received at said receiver.

6. The method of claim 1 further comprising:
streaming data at said intermediate transmission rate for a specified period of time, said period of time allowing an amount of said data encoded at said first encoding rate to accumulate in memory of said receiver.

7. The method of claim 1 wherein said data is streamed according to Transmission Control Protocol (TCP).

8. The method of claim 1 wherein said data is selected from the group consisting of: video data, audio data, and multimedia data.

9. A method of streaming data, said method comprising:
accessing data encoded at a first encoding rate and at a second encoding rate, said first encoding rate corresponding to a first playback rate and said second encoding rate corresponding to a second playback rate;
transmitting first encoded data to a receiver at a first transmission rate, said first encoded data encoded at said first encoding rate;
increasing said first transmission rate to an intermediate transmission rate that is greater than said first playback rate but less than said second playback rate;
maintaining said intermediate transmission rate for a prescribed period of time to accumulate a specified amount of data in memory at said receiver; and
at the end of said prescribed period of time, increasing said intermediate transmission rate to a second transmission rate, wherein said first encoded data are transmitted at said second transmission rate.

10. The method of claim 9 wherein said first transmission rate is substantially equal to said first encoding rate and said second transmission rate is substantially equal to said second encoding rate.

11. The method of claim 9 further comprising:
transmitting second encoded data at said second transmission rate instead of said first encoded data, said second encoded data encoded at said second encoding rate.

12. The method of claim 12 further comprising:
determining that there is sufficient bandwidth at said second transmission rate before switching from said first encoded data to said second encoded data.

13. The method of claim 12 further comprising:
receiving information from said receiver that characterizes whether said first encoded data is being received at a receiver.

14. The method of claim 9 wherein said prescribed period of time is chosen so that playback of said first encoded data can continue if said receiver receives said first encoded data at less than said first playback rate.

15. A system for streaming data, said system comprising:
a streaming element for receiving first data encoded at a first encoding rate that corresponds to a first playback rate and for streaming said first data at a plurality of transmission rates, wherein said first data are streamed to a receiver at a first transmission rate, then at an intermediate transmission rate that is greater than said first transmission rate and greater than said first playback rate, and then at a second transmission rate that is greater than said intermediate transmission rate; and
a processing element coupled to said streaming element, said processing element for making a determination whether there is sufficient bandwidth for said second transmission rate, wherein provided said bandwidth is sufficient said streaming element then receives second data encoded at a second encoding rate that corresponds to a second playback rate and streams to said receiver said second data at said second transmission rate instead of said first data.

16. The system of claim 15 further comprising:
an encoding element coupled to said streaming element, said encoding element for encoding said first data.

17. The system of claim 15 further comprising:
a storage element coupled to said streaming element, said storage element for storing said first data and said second data prior to streaming of said first data and said second data.

18. The system of claim 15 wherein said processing element makes said determination using information that characterizes an amount of said first data received at said receiver.

19. The system of claim 15 wherein said data is streamed according to Transmission Control Protocol (TCP).

20. The system of claim 15 wherein said data is selected from the group consisting of: video data, audio data, and multimedia data.
